(19) United States
(12) Patent Application Publication
(10) Pub. No.: US 2026/0079657 A1
(43) Pub. Date: Mar. 19, 2026

(54) METHOD FOR GENERATING PRINT DATA, PRINT DATA GENERATING APPARATUS, AND STORAGE MEDIUM

(71) Applicant: CASIO COMPUTER CO., LTD., Tokyo (JP)

(72) Inventor: Teruo HASHIMOTO, Tokyo (JP)

(73) Assignee: CASIO COMPUTER CO., LTD., Tokyo (JP)

(21) Appl. No.: 19/324,655

(22) Filed: Sep. 10, 2025

(30) Foreign Application Priority Data
Sep. 17, 2024 (JP) 2024-160130

(51) Int. Cl. G06F 3/12

(52) U.S. Cl. CPC G06F 3/1251; G06F 3/1206

(57) ABSTRACT

A method for generating print data includes: receiving, by a computer, input of print information to an input area of a print design in which sample information is displayed in the input area; and repeatedly arranging, by the computer, the print information in the input area in such a manner as to make a size of a range in which the print information is arranged closer to a size of a range of the sample information in the print design.

### CROSS-REFERENCE TO RELATED APPLICATIONS

This application is based upon and claims the benefit of priority under 35 USC 119 of Japanese Patent Application No. 2024-160130, filed on Sep. 17, 2024, the entire disclosure of which, including the description, claims, drawings, and abstract, is incorporated herein by reference in its entirety.

### TECHNICAL FIELD

The present disclosure relates to a method for generating print data, a print data generating apparatus, and a storage medium.

### BACKGROUND

JP H6-143694 A describes a printing apparatus that obtains a desired print output without requiring complicated management and complicated control for tapes having various widths by determining a print font to be used for printing of each row from a magnitude relationship of each row character string and a tape width specified prior to printing.

### SUMMARY

A method for generating print data according to an aspect of the present disclosure includes: receiving, by a computer, input of print information to an input area of a print design in which sample information is displayed in the input area; and repeatedly arranging, by the computer, the print information in the input area in such a manner as to make a size of a range in which the print information is arranged closer to a size of a range of the sample information in the print design.

A print data generating apparatus according to an aspect of the present disclosure includes: at least one processor that receives input of print information to an input area of a print design in which sample information is displayed in the input area, and repeatedly arranges the print information in the input area in such a manner as to make a size of a range in which the print information is arranged closer to a size of a range of the sample information in the print design.

A storage medium according to an aspect of the present disclosure is a non-transitory storage medium storing a program readable by a computer, the program causes the computer to implement a control function of: receiving input of print information to an input area of a print design in which sample information is displayed in the input area; and repeatedly arranging the print information in the input area in such a manner as to make a size of a range in which the print information is arranged closer to a size of a range of the sample information in the print design.

According to the above aspect, it is possible to provide a technique of generating print data capable of printing a desired design.

### BRIEF DESCRIPTION OF THE DRAWINGS

FIG. 1 is a diagram illustrating a configuration of a printing system;

FIG. 2 is a block diagram illustrating an example of a hardware configuration of an information processing apparatus;

FIG. 3 is a flowchart illustrating an example of processing performed by the information processing apparatus;

FIG. 4 is an example of a format selection screen;

FIG. 5 is an example of a label image display screen before editing;

FIG. 6 is an example of a label image editing screen before editing;

FIG. 7 is an example of the label image editing screen after editing;

FIG. 8 is another example of the label image display screen after editing;

FIG. 9 is still another example of the label image display screen after editing; and

FIG. 10 is still another example of the label image display screen after editing.

### DETAILED DESCRIPTION

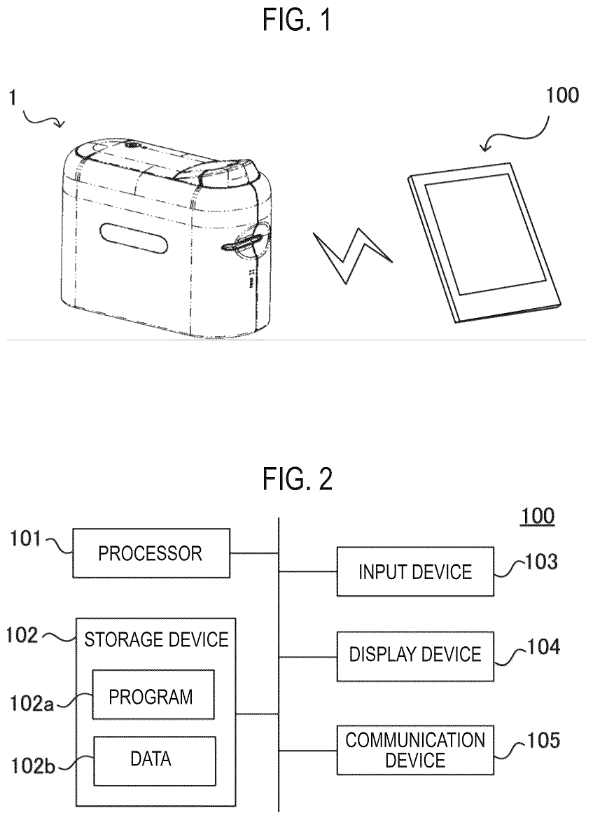

An embodiment of the present disclosure will be described with reference to the drawings. Hereinafter, the embodiment of the present disclosure will be described by taking a system illustrated in FIG. 1, as an example, which includes a printing apparatus 1 capable of printing characters, images, and the like on a tape that is a print medium, cutting the printed tape (label), and discharging the tape to the outside of the apparatus, and an information processing apparatus 100 in which an application (label generation support application) that supports generation of the label is operated. In the system illustrated in FIG. 1, the information processing apparatus 100 outputs print data including a label image to the printing apparatus 1, so that the printing apparatus 1 prints the label image on the tape to generate the label on which the label image is printed.

In the present specification, the tape is an elongated thin band-shaped print medium made of plastic, paper, or any other material. The tape typically has an adhesive layer and is attachable. However, the tape does not necessarily have the adhesive layer. In addition, the label is obtained by printing some information on the tape using the tape as a print medium. A printing method of the printing apparatus 1 according to the embodiment is not particularly limited. The printing apparatus 1 is, for example, a thermal printer that performs printing by a thermal transfer method or a thermal method. However, the printing apparatus 1 is not limited to the thermal printer, and may be an inkjet printer, a laser printer, or the like. The printing apparatus 1 and the information processing apparatus 100 exchange data by, for example, wireless communication, but the communication between the printing apparatus 1 and the information processing apparatus 100 is not limited to the wireless communication, and may be communication using a wired cable.

The information processing apparatus 100 is an apparatus that generates a label image to be printed on a label by the printing apparatus 1 and transmits print data including the label image to the printing apparatus 1, and is a computer on which a label generation support application operates. The information processing apparatus 100 can generate any label image, and can also generate a label image for a cut label using a format of a print design prepared in advance. The cut label is a label generated with a tape punched in advance into a shape such as a circle or a square, and the label image for the cut label is generated in accordance with the punched shape such as a circle or a square. Note that the information processing apparatus 100 only needs to be able to generate print data including a label image, and may be, for example, a mobile terminal such as a tablet terminal, a notebook terminal, or a smartphone. In addition, the information processing apparatus 100 is not limited to the mobile terminal, and may be a stationary apparatus.

For example, as illustrated in FIG. 2, the information processing apparatus 100 includes a processor 101, a storage device 102, an input device 103, a display device 104, and a communication device 105 which may be connected to each other via a bus. The processor 101 is an example of a control unit of the information processing apparatus 100. The processor 101 includes, for example, a central processing unit (CPU) and executes a program 102a stored in the storage device 102. The processor 101 may include any electric circuit such as a graphics processing unit (GPU), an application specific integrated circuit (ASIC), a field-programmable gate array (FPGA), or a digital signal processor (DSP). The storage device 102 is a non-transitory computer-readable medium, for example, any semiconductor memory. One or more storage devices 102 include a volatile memory such as a random access memory (RAM), and a nonvolatile memory such as a read only memory (ROM) or a flash memory. In addition, the storage device 102 may include a magnetic storage device, an optical storage device, and other types of storage devices. The storage device 102 desirably stores a program 102a and data 102b. The program 102a is, for example, an application (the label generation support application) that supports label generation. The data 102b includes, for example, a format of a print design for a cut label to be described later. The input device 103 includes, for example, a touch panel, a keyboard, a mouse, or the like. The input device 103 may further include a voice input device such as a microphone. The display device 104 is, for example, a liquid crystal display, an organic EL display, or the like. The communication device 105 is, for example, a device that exchanges data with the printing apparatus 1 by wireless communication.

In the information processing apparatus 100 of the system configured as described above, the processor 101 executes the program 102a to generate a label image. Further, print data including the label image generated by the information processing apparatus 100 is transmitted to the printing apparatus 1, whereby a label on which the label image is printed is generated by the printing apparatus 1. Hereinafter, a method by which the information processing apparatus 100 generates print data will be specifically described by taking, as an example, a case where the label generation support application is executed to generate a label image of a cut label.

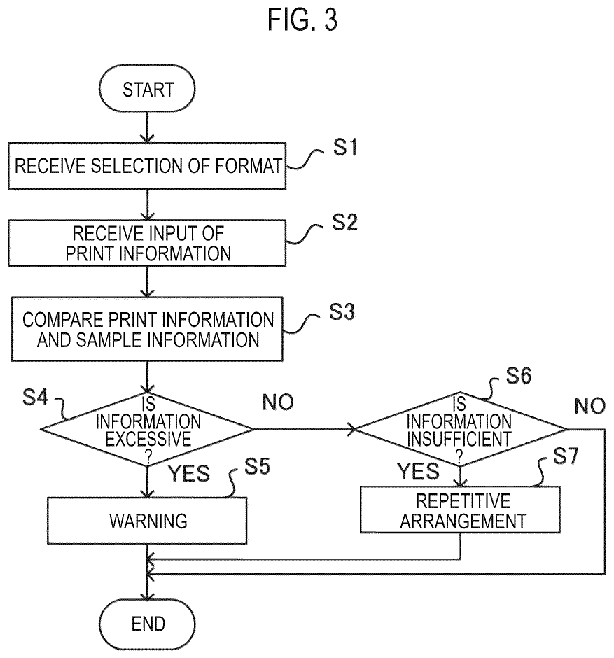

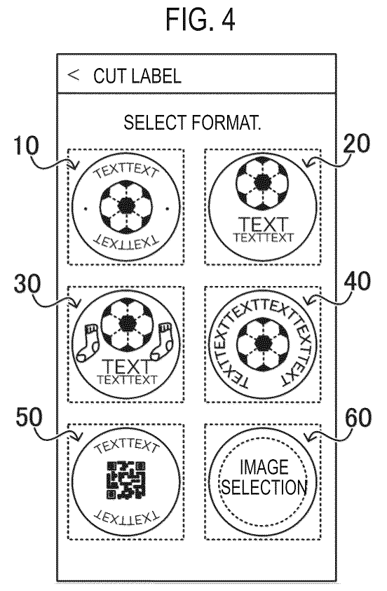

In response to the execution of the program 102a by the processor 101 of the information processing apparatus 100 and selection of generating print data for a cut label by a user, processing illustrated in FIG. 3 is started. First, the processor 101 displays a format selection screen illustrated in FIG. 4 on the display device 104, and receives the selection of a format of a print design from the user (step S1). FIG. 4 illustrates six formats (a format 10, a format 20, a format 30, a format 40, a format 50, and a format 60) of print designs. The print designs corresponding to the respective formats are samples of label images for cut labels. Among these, each of the print designs corresponding to the five formats 10 to 50 has an input area to which any print information to be printed on a label can be input, and sample information is displayed in the input area. The sample information is a sample of the print information input to the input area, and is one or more repetitions of a character string “TEXT” in FIG. 4. A range of the sample information in the entire print design affects an impression that the print design gives to the user. The sample information indicates a specific example of a length and a font size of the print information that needs to be input to the input area based on the design to be realized in each of the formats. That is, in response to generating a label image using each of the formats by the user, a desired design to be realized in each of the formats can be easily reproduced in a label on which any print information is printed by inputting print information to the input area such that the range of the sample information in the print design of the selected format is similar to a range of the print information input to the input area by the user.

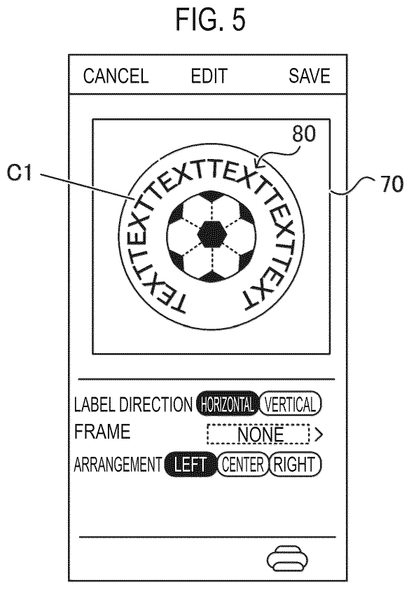

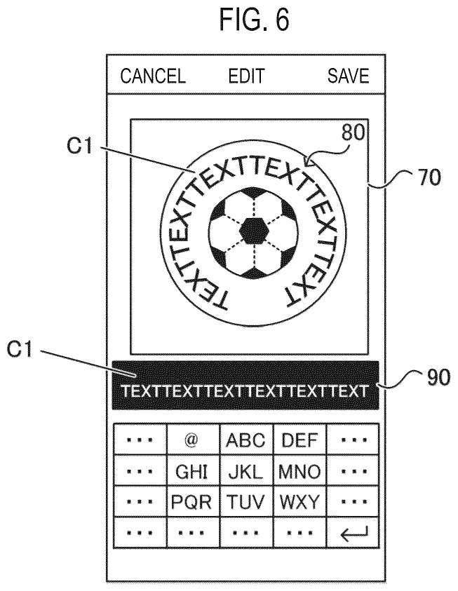

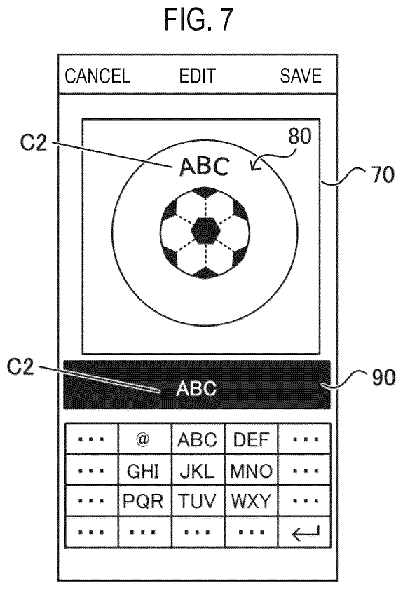

In response to the reception of the selection of the format, the processor 101 then receives input of print information to the input area (step S2). Here, a case where the user selects the format 40 in step S1 and the processor 101 receives the selection of the format 40 will be described as an example. In response to the reception of the selection of the format 40, the processor 101 first causes the display device 104 to display a print design corresponding to the format 40 selected by the user, that is, a label image display screen in which a label image is displayed large in a label image area 70 as illustrated in FIG. 5. In an input area 80 in the label image displayed on the display device 104, sample information C1 in the print design corresponding to the format 40 is displayed in advance. Thereafter, as the user selects the input area 80, the processor 101 causes the display device 104 to display a label image editing screen including an input box 90 illustrated in FIG. 6 for editing information displayed in the input area 80. At this time, the sample information C1 displayed in the input area 80 is input to the input box 90. As the user edits the sample information C1 displayed in the input box 90 to any print information on the label image editing screen, the processor 101 receives input of the print information to the input area 80. FIG. 7 illustrates a state in which the sample information C1 is edited to print information C2.

As described above, the range of the print information in the label image affects the impression given by the label image. Therefore, if the range of the print information in the label image is greatly different from the range of the sample information in the print design, the impression given by the generated label image is different from the print design corresponding to the selected format. In view of such a point, in response to the reception of the print information in step S2 in the information processing apparatus 100, the processor 101 operates as follows.

First, the processor 101 compares the print information with the sample information (step S3). Here, the processor 101 compares these pieces of information based on the number of characters, for example. In a case where the number of characters of a character string included in the print information (hereinafter, simply referred to as the number of characters of the print information) is larger than the number of characters of a character string included in the sample information (hereinafter, simply referred to as the number of characters of the sample information) and exceeds a first reference value, the processor 101 determines that the print information is excessive (YES in step S4), warns that it is difficult to achieve a desired design that needs to be realized by the selected format (step S5), and ends the processing illustrated in FIG. 3 without editing the print information C2. As a result, the label image having an impression different from the print design corresponding to the selected format is generated. Note that the first reference value is, for example, the maximum number of characters fitting within the input area with a font size determined in advance for the input area.

On the other hand, in response to the number of characters in the print information being smaller than the number of characters in the sample information and equal to or smaller than a second reference value, the processor 101 determines that the print information is insufficient (NO in step S4), and repeatedly arranges the print information in the input area (step S7). More specifically, the processor 101 repeatedly arranges the print information in the input area such that a size of the range in which the print information is arranged in the label image to be generated becomes closer to a size of the range of the sample information in the print design corresponding to the selected format. As a result, the label image having an impression similar to the print design corresponding to the selected format is generated. Note that the second reference value is, for example, half the number of characters of the sample information.

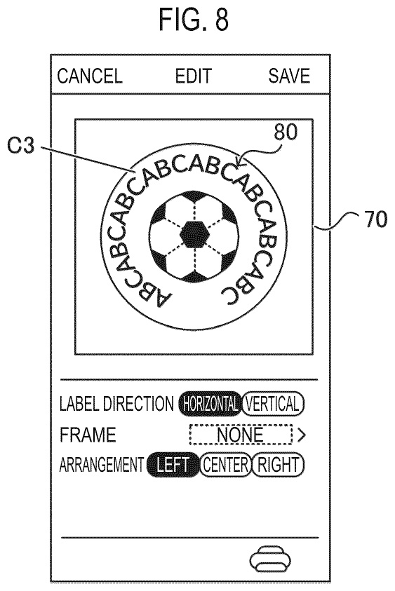

In step S7, for example, the processor 101 may determine the number of repetitive arrangements based on the number of characters of the print information and the number of characters of the sample information. More specifically, for example, the processor 101 may determine the number of repetitive arrangements by dividing the number of characters of the sample information by the number of characters of the print information. In a case where the print information C2 illustrated in FIG. 7 is input, the number of characters of the sample information C1 is 24 and the number of characters of the print information C2 is 3, 24/3=8 times is determined. FIG. 8 illustrates an example in which the processor 101 repeatedly arranges the print information C2 in the input area 8 times, and as a result, print information C3, generated by repeatedly arranging the print information C2 8 times, is displayed in the input area 80. In a case where the number of characters of the sample information is not divisible by the number of characters of the print information, the number of times may be determined by rounding up or down a fractional part. Whether to round up or down the fractional part may be determined by which of a case where the number of characters of the print information is multiplied by the number of times determined by rounding up the fractional part, and a case where the number of characters of the print information is multiplied by the number of times determined by rounding down the fractional part is closer to the number of characters of the sample information. In this case, the number of times in the case where the number of characters is closer may be determined.

Further, in response to the number of characters of the print information exceeding the second reference value but being equal to or smaller than the first reference value, the processor 101 determines that the print information is neither excessive nor insufficient (NO in step 4 and NO in step S6), and ends the processing illustrated in FIG. 3 without editing the print information C2. In this case as well, the label image having an impression similar to the print design corresponding to the selected format is generated.

As the processing illustrated in FIG. 3 is performed as described above, the information processing apparatus 100 can easily generate the label image of the desired design, that is, the label image having an impression close to the print design of the selected format, and can generate print data including the generated label image. That is, the print data capable of printing the desired design can be generated. Specifically, in a case where it is determined that the print information input by the user to the input box 90 contains insufficient information in terms of a design, the information processing apparatus 100 automatically repeats the arrangement of the print information in the input area such that the size of the range in which the print information is arranged (more specifically, a range in which the print information is repeatedly arranged) becomes closer to the size of the range of the sample information. As a result, it is possible to generate the label image having an impression close to the print design of the selected format without bothering the user while maintaining the information, which has been input by the user and needs to be displayed in the label image, without losing the information. In particular, by determining the number of repetitions based on the comparison of the number of characters, sizes of display ranges of the sample information and the print information can be made approximately the same with a simple calculation.

Although a case where the label image is generated without changing a font size of the print information from the font size of the sample information has been described as an example in FIG. 3, the font size may be adjusted as necessary. For example, in step S7, in a case where the number of characters of the sample information is not divisible by the number of characters of the print information, the font size of the print information may be changed from the same font size as the sample information, and the print information with the changed font size may be repeatedly arranged in the input area by the determined number of times of repetition. In this case, the font size may be decreased in the case where the number of repetitions is determined by rounding up the fractional part, and the font size may be increased in the case where the number of repetitions is determined by rounding down the fractional part. That is, the processor 101 may repeatedly expand or contract the print information and arrange the expanded and contracted print information in the input area so as to make that the size of the range in which the print information is arranged closer to the size of the range of the sample information in the print design. As a result, since the size of the range of the sample information and the size of the range in which the print information is repeatedly arranged become more similar, the label image having an impression more similar to the print design can be generated. Also in a case where it is determined that the print information is neither excessive nor insufficient, the font size may be adjusted so as to further make the size of the range in which the print information is arranged closer to the size of the range of the sample information. Furthermore, in a case where it is determined that the print information is excessive, the font size may be decreased so as to make the size of the range in which the print information is arranged closer to the size of the range of the sample information.

The above-described embodiment has been given as a specific example to facilitate understanding of the disclosure, and the present disclosure is not limited to the above-described embodiment, and should be understood as including various modifications and alternative embodiments of the above-described embodiment. For example, it will be understood that the above-described embodiment can be implemented by modifying components without departing from the spirit thereof. It will be understood that various embodiments can be implemented by appropriately combining a plurality of components disclosed in the above-described embodiment. Furthermore, a person skilled in the art may understand that various embodiments can be implemented by removing some of all the components illustrated in the embodiment or adding some components to the components illustrated in the embodiment.

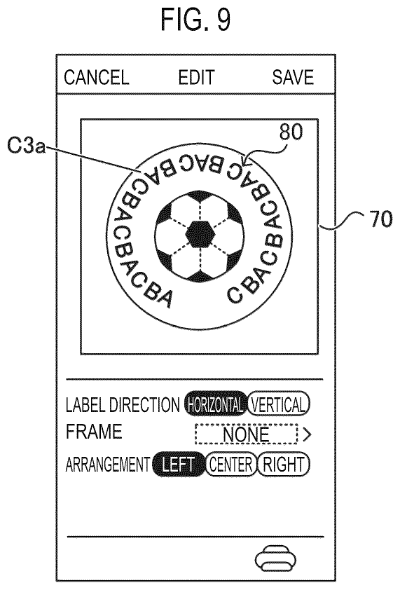

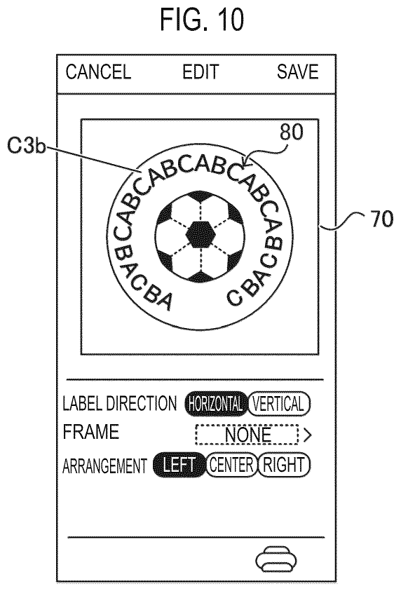

Although the example of selecting a format for a cut label has been described in the above-described embodiment, a format to be selected is not limited to the format for the cut label, and may be a format for any print medium. Although the example in which the font size is adjusted in order to make the size of the range in which the print information is arranged closer to the size of the range of the sample information has been described in the above-described embodiment, for example, the sizes of the two ranges may be made close to each other by adding a blank or a predetermined symbol between repeatedly arranged character strings. Although the example in which the input area in which the character string is arranged in the circumferential direction has been exemplified in the above-described embodiment, the arrangement of the input area is not particularly limited to this example. The input area may be an area in which the character string is arranged in a direction (for example, the radial direction or the like) other than the circumferential direction. Although the example in which the character string is input to the input area has been described in the above-described embodiment, the print information input to the input area is not limited to the character string, and may be, for example, an image. Although the example in which the character string is displayed with the radially outer side as the top has been described in the above-described embodiment, the character string may be displayed with the radially inner side as the top, for example, as in print information C3a illustrated in FIG. 9. Further, as in print information C3b illustrated in FIG. 10, characters may be vertically inverted between the upper half and the lower half of the character string arranged along the circumferential direction.

What is claimed is:

1. A method for generating print data, comprising:
receiving, by a computer, input of print information to an input area of a print design in which sample information is displayed in the input area; and
repeatedly arranging, by the computer, the print information in the input area in such a manner as to make a size of a range in which the print information is arranged closer to a size of a range of the sample information in the print design.

2. The method for generating print data according to claim 1, wherein
the computer repeatedly expands or contracts the print information and arranges the expanded or contracted print information in the input area in such a manner as to make the size of the range in which the print information is arranged closer to the size of the range of the sample information in the print design.

3. The method for generating print data according to claim 1, wherein
the computer determines a number of times of repeatedly arranging the print information in the input area based on a number of characters of a character string forming the print information and a number of characters of a character string forming the sample information.

4. The method for generating print data according to claim 1, wherein
a plurality of the print designs having mutually different formats are stored in advance in a memory, and
the input of the print information with respect to the input area is received for the print design selected by a user from among the plurality of print designs.

5. The method for generating print data according to claim 4, wherein
any one of the plurality of print designs has the input area provided at a position surrounding an image arranged at a center, and
another one of the plurality of print designs has an image arranged at a position biased to one end, and the input area is provided at a position biased to another end.

6. The method for generating print data according to claim 1, wherein
the print information is text information.

7. The method for generating print data according to claim 1, wherein
the sample information is text information.

8. A print data generating apparatus comprising:
at least one processor that receives input of print information to an input area of a print design in which sample information is displayed in the input area, and repeatedly arranges the print information in the input area in such a manner as to make a size of a range in which the print information is arranged closer to a size of a range of the sample information in the print design.

9. The print data generating apparatus according to claim 8, wherein
the at least one processor repeatedly expands or contracts the print information and arranges the expanded or contracted print information in the input area in such a manner as to make the size of the range in which the print information is arranged closer to the size of the range of the sample information in the print design.

10. The print data generating apparatus according to claim 8, wherein
the at least one processor determines a number of times of repeatedly arranging the print information in the input area based on a number of characters of a character string forming the print information and a number of characters of a character string forming the sample information.

11. The print data generating apparatus according to claim 8, further comprising
a memory in which a plurality of the print designs having mutually different formats are stored in advance, wherein
the at least one processor receives the input of the print information with respect to the input area for the print design selected by a user from among the plurality of print designs.

12. The print data generating apparatus according to claim 11, wherein
any one of the plurality of print designs has the input area provided at a position surrounding an image arranged at a center, and
another one of the plurality of print designs has an image arranged at a position biased to one end, and the input area is provided at a position biased to another end.

13. The print data generating apparatus according to claim 8, wherein
the print information is text information.

14. The print data generating apparatus according to claim 8, wherein
the sample information is text information.

15. A non-transitory storage medium storing a program readable by a computer, the program causing the computer to implement a control function of:
receiving input of print information to an input area of a print design in which sample information is displayed in the input area; and
repeatedly arranging the print information in the input area in such a manner as to make a size of a range in which the print information is arranged closer to a size of a range of the sample information in the print design.

16. The storage medium according to claim 15, wherein
the control function repeatedly expands or contracts the print information and arranges the expanded or contracted print information in the input area in such a manner as to make the size of the range in which the print information is arranged closer to the size of the range of the sample information in the print design.

17. The storage medium according to claim 15, wherein
the control function determines a number of times of repeatedly arranging the print information in the input area based on a number of characters of a character string forming the print information and a number of characters of a character string forming the sample information.

18. The storage medium according to claim 15, wherein
a plurality of the print designs having mutually different formats are stored in advance in a memory, and
the control function receives the input of the print information with respect to the input area for the print design selected by a user from among the plurality of print designs.

19. The storage medium according to claim 18, wherein
any one of the plurality of print designs has the input area provided at a position surrounding an image arranged at a center, and
another one of the plurality of print designs has an image arranged at a position biased to one end, and the input area is provided at a position biased to another end.

20. The storage medium according to claim 15, wherein
the print information or the sample information is text information.
